(19) United States
(12) Patent Application Publication
(10) Pub. No.: US 2009/0004464 A1
(43) Pub. Date: Jan. 1, 2009

(54) Light-Reflective Articles and Methods for Making Them

(76) Inventors: David A. Diehl, Pittsburgh, PA (US); Jeanne D. Housman, Chestnut Hill, MA (US)

Correspondence Address: THE ECLIPSE GROUP LLP, 10605 BALBOA BLVD., SUITE 300, GRANADA HILLS, CA, 91344, US

(21) Appl. No.: 11/768,893

(22) Filed: Jun. 26, 2007

(51) Int. Cl. B32B 23/08; B05D 1/36; B05D 3/06

(52) U.S. Cl. 428/336; 427/294; 427/407.1; 427/508; 428/500

(57) ABSTRACT

Article including light-reflective layer over primer layer over substrate. Substrate has first composition including polymer. Primer layer has second composition including polymer, and polymer-bound nucleophilic moiety selected from carboxylic acids, organophosphorus acids, organosulfur acids, nitrocellulose, or mixture. Light-reflective layer has third composition including metal element. Substrate has first posterior and anterior surfaces. Primer layer has second posterior and anterior surfaces. Light-reflective layer has third posterior and anterior surfaces. Second posterior surface faces first anterior surface and third posterior surface faces second anterior surface. Third anterior surface is optically smooth. Primer layer and light-reflective layer are molecularly bonded together. Method that includes providing substrate, forming primer layer, and forming light-reflective layer.

### BACKGROUND OF THE INVENTION

1. Field of the Invention

This invention generally relates to multi-layer light-reflective articles having a light-reflective layer including a metal element.

2. Related Art

Various types of multi-layer light-reflective articles have been developed having a light-reflective layer including a metal element. Examples include articles and apparatus having a reflective or shiny chromed appearance, such as accent panels, grilles, and insignia for vehicles and for other devices and apparatus. Further examples include mirrors, architectural detailing, sales displays, and personal accessories such as jewelry and sunglasses. Articles and apparatus having a reflective or shiny chromed appearance, such as a vehicle grille, are in some cases fabricated as metallic-supported structures.

Efforts have been made to develop organic polymer-supported structures for articles having a reflective or shiny chromed appearance, as replacements for metallic-supported structures. Metallic-supported structures, as well as reflective structures including glass mirror layers, as examples, typically are heavy compared to organic polymer-supported structures having similar dimensions. The weight of metallic-supported structures and other non-polymeric components such as glass mirror layers is a significant problem in certain end-use applications for light-reflective surfaces, such as automotive mirrors and portable articles. In addition, problems with organic polymer-supported structures have included poor durability, poor structural integrity, de-lamination of multi-layer constructions, poor adhesion in particular of plastic substrates to light-reflective layers including a metal element, degradation by abrasion, by heat-cold cycling, and by exposure to environmental conditions such as weather. Fabrication of articles with organic polymer-supported structures has also been subject to difficulties in fabricating articles having complex and detailed shapes, as well as process technology hazards.

Problems in process technologies for fabricating such organic polymer-supported structures have resulted in part from reliance on electroplating to form the light-reflective layers. Electroplating typically requires deposition of a composition including one or more metal elements for forming a light-reflective layer by utilization of a toxic liquid solution including metal-containing compounds such as soluble salts or complexes. These toxic solutions are a serious hazard to the health of workers during manufacturing of the light-reflective layers, and disposal of spent electroplating solutions is a major environmental hazard. Restrictions on the utilization of solution-based electroplating in manufacturing processes continue to expand, and solution electroplating may ultimately be widely banned altogether.

Attempts to integrate an organic polymer-supported structure and a light-reflective layer including a metal element have further suffered from difficulties in making articles or apparatus meeting performance test standards required for commercial acceptability in various end-uses, such as the automotive field. Consequently, there is a continuing need for new articles, including articles incorporated into other articles or apparatus, which articles include an organic polymer-containing support structure and a light-reflective surface including a metal element.

### SUMMARY

In an example of an implementation, an article is provided, including a substrate, a primer layer, and a light-reflective layer. The substrate has a first posterior surface, a first anterior surface, and a first composition including a polymer. The primer layer is over and has a second posterior surface facing the first anterior surface and the primer layer has a second anterior surface. The primer layer has a second composition including a polymer, and includes a polymer-bound nucleophilic moiety selected from carboxylic acids, organophosphorus acids, organosulfur acids, nitrocellulose, and a mixture of two or more of the foregoing. The light-reflective layer is over and has a third posterior surface facing the second anterior surface. The light-reflective layer has an optically smooth third anterior surface and has a third composition including a metal element. The primer layer and the light-reflective layer are molecularly bonded together.

In an example, the article may further include a bonding interface of the second anterior surface and the third posterior surface, the bonding interface including a reaction product of the metal element and the polymer-bound nucleophilic moiety. As another example, the reaction product at the bonding interface may include a salt that includes the metal element and the polymer-bound nucleophilic moiety. In a further example, the substrate and the primer layer may be molecularly bonded together. Further, the article may include a second bonding interface of the first anterior surface and the second posterior surface, which may include, for example, a reaction product of the first composition polymer with such a polymer-bound nucleophilic moiety. The light-reflective layer may, in an example, be formed by vacuum deposition of the third composition over the second anterior surface.

The article may, for example, additionally include a protective layer over and having a fourth posterior surface facing the third anterior surface, the protective layer having a fourth anterior surface. The protective layer has a fourth composition that may as examples include an organic composition, an inorganic composition, or both. The light-reflective layer and the protective layer may be molecularly bonded together. As examples, the fourth composition may include an inorganic composition such as diamond-like carbon (“DLC”), aluminum nitride, silicon dioxide, C₂N₂, or a mixture of two or more of the foregoing. As further examples, the fourth composition may include an organic composition such as a poly(olefin), poly(vinyl chloride), poly(styrene), poly(fluoroethylene), poly(acrylate), poly(vinyl acid ester), poly(carbonate), poly(ester), poly(urethane), poly(amide), poly(unsaturated ester), poly(acrylonitrile butadiene styrene), poly(styrene acrylonitrile), or a mixture of two or more of the foregoing or including one or more inorganic compositions. As a further example, the article may include a tie layer interposed between the third anterior surface and the fourth posterior surface, the tie layer having a fifth posterior surface facing the third anterior surface, the tie layer having a fifth anterior surface facing the fourth posterior surface.

As another example of an implementation, a method is provided that includes providing a substrate, forming a primer layer over the substrate, and forming a light-reflective layer over the primer layer. Providing the substrate includes providing a substrate having a first posterior surface, a first anterior surface, and a first composition including a polymer. Forming the primer layer includes forming a primer layer over and having a second posterior surface facing the first anterior surface, the primer layer having a second anterior surface. Forming the primer layer further includes polymerizing monomers to form a second composition including a polymer, and including a polymer-bound nucleophilic moiety selected from carboxylic acids, organophosphorus acids, organosulfur acids, nitrocellulose, and a mixture of two or more of the foregoing. Forming the light-reflective layer includes forming a light-reflective layer over and having a third posterior surface facing the second anterior surface. Forming the light-reflective layer further includes forming a light-reflective layer having an optically smooth third anterior surface and having a third composition including a metal element. Forming the light-reflective layer also includes molecularly bonding together the primer layer and the light-reflective layer.

Forming the light-reflective layer may, for example, additionally include forming a bonding interface of the second anterior surface and the third posterior surface, the bonding interface including a reaction product of the metal element and the polymer-bound nucleophilic moiety.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention can be better understood with reference to the following figures. The components in the figures are not necessarily to scale, emphasis instead being placed upon illustrating the principles of the invention. Moreover, in the figures, like reference numerals designate corresponding parts throughout the different views.

FIG. 1 is a cross-sectional side view showing an example of an implementation of an article.

FIG. 2 is a cross-sectional side view showing an example of another implementation of an article.

FIG. 3 is a cross-sectional side view showing another example of the article shown in FIG. 2.

FIG. 4 is a cross-sectional side view showing an example of an additional implementation of an article.

FIG. 5 is a flow chart showing an example of an implementation of a method.

### DETAILED DESCRIPTION

An article is provided that includes a substrate, a primer layer over the substrate, and a light-reflective layer over the primer layer. The substrate has a first composition including a polymer. The primer layer has a second composition including a polymer, and including a polymer-bound nucleophilic moiety selected from carboxylic acids, organophosphorus acids, organosulfur acids, nitrocellulose, and a mixture of two or more of the foregoing. The light-reflective layer has a third composition including a metal element. The substrate has first posterior and anterior surfaces. The primer layer has second posterior and anterior surfaces. The light-reflective layer has third posterior and anterior surfaces. The second posterior surface of the primer layer faces the first anterior surface of the substrate. The third posterior surface of the light-reflective layer faces the second anterior surface of the primer layer. The third anterior surface of the light-reflective layer is optically smooth. The primer layer and the light-reflective layer are molecularly bonded together.

The third posterior surface of the light-reflective layer and the second anterior surface of the primer layer may, as an example, form a bonding interface that includes a reaction product of the metal element in the third composition and the polymer-bound nucleophilic moiety in the second composition. The reaction product at the bonding interface may include, for example, a salt that includes the metal element and the polymer-bound nucleophilic moiety. In another example, the substrate and the primer layer may be molecularly bonded together. The second posterior surface of the primer layer and the first anterior surface of the substrate may form a second bonding interface including, for example, a reaction product of the first composition with the polymer-bound nucleophilic moiety in the second composition. The article may, for example, additionally include a protective layer over the light-reflective layer. The protective layer has fourth posterior and anterior surfaces. The fourth posterior surface of the protective layer faces the third anterior surface of the light-reflective layer. As an example, the light-reflective layer and the protective layer may be molecularly bonded together. The protective layer has a fourth composition that may include an organic composition, an inorganic composition, or both. As examples, the fourth composition may include an inorganic composition such as diamond-like carbon, aluminum nitride, silicon dioxide, C₂N₂, or a mixture of two or more of the foregoing. As further examples, the fourth composition may include an organic composition such as a poly(olefin), poly(vinyl chloride), poly(styrene), poly(fluoroethylene), poly(acrylate), poly(vinyl acid ester), poly(carbonate), poly(ester), poly(urethane), poly(amide), poly(unsaturated ester), poly(acrylonitrile butadiene styrene), poly(styrene acrylonitrile), or a mixture of two or more of the foregoing or including one or more inorganic compositions. A tie layer having a fifth posterior surface facing the third anterior surface of the light-reflective layer, and having a fifth anterior surface, may be interposed between the light-reflective layer and the protective layer.

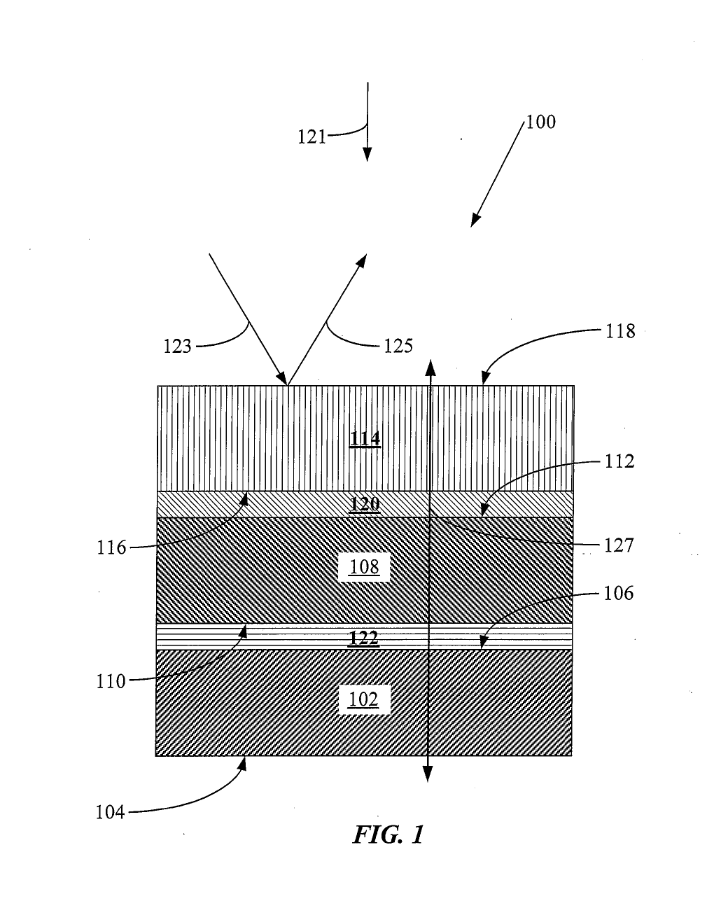

FIG. 1 is a cross-sectional side view showing an example of an implementation of an article 100. The article 100 includes a substrate 102 having a first posterior surface 104 and a first anterior surface 106. The substrate 102 has a first composition including a polymer. The article 100 also includes a primer layer 108 over the substrate 102. The primer layer 108 has a second posterior surface 110 and a second anterior surface 112. The second posterior surface 110 of the primer layer 108 faces the first anterior surface 106 of the substrate 102.

The primer layer 108 has a second composition including a polymer, and including a polymer-bound nucleophilic moiety selected from carboxylic acids, organophosphorus acids, organosulfur acids, nitrocellulose, and a mixture of two or more of the foregoing. Such nucleophilic moieties as may be located at the second posterior and anterior surfaces 110, 112 of the primer layer 108, for example, are available for molecular bonding. Throughout this specification, the terms “molecularly bonded” and “molecular bond” denote a bonding interaction involving one or more types of interactions selected from covalent bonding, ionic bonding, and formation of a complex.

The following conventions are understood throughout this specification by those skilled in the art. The term “complex” denotes coordination of an ion or of a second molecule with a first molecule and involving at least partial sharing of an electron. Examples of a complex include transition metal complexes and carboxylic acid salts. A “carboxylic acid” moiety is a moiety having the chemical structure, —R—(C═O)—OH, where —R represents a carbon chain covalently bound to the subject polymer, and —(C═O)—OH denotes a hydroxyl-carbonyl group. The hydroxyl-carbonyl group may also be in dehydrogenated —(C═O)—O— ionic form. The carboxylic acid moiety may further be in the form of a carboxylic acid salt, in the form of an anhydride corresponding to a dicarboxylic acid, in an esterified form, or in the form of an acyl halide. An acyl halide substitutes the hydroxyl group by a halogen and has the formula —R—(C═O)—X where —C═O denotes a carbonyl group and —X denotes a halogen such as chlorine, bromine or iodine. An “organophosphorus acid” moiety is a moiety having the chemical structure —R₁—(P═O)—R₂—R₃ or the chemical structure —R₁—P—(OH)₂, where in either chemical structure —R₁ represents a carbon chain covalently bound to the subject polymer, —R₂ represents a hydroxyl (—OH) group, and —R₃ represents either a hydroxyl (—OH) group or a hydrogen atom. The hydroxyl group(s) in the organophosphorus acid may also be in dehydrogenated —(O—) ionic form. The organophosphorus acid moiety may also be in the form of an organophosphorus acid salt, in an esterified form, or in the form of an organophosphorus acid halide. An organophosphorus acid halide substitutes a hydroxyl group by a halogen. The use of neurotoxic organophosphorus anhydrides is excluded. Common names for examples of types of nucleophilic organophosphorus moieties include phosphates, phosphonates, organophosphonic acids, and mono- and diesters of phosphoric acid or of ortho-phosphoric acid. An “organosulfur acid” moiety is a moiety having the chemical structure —R₁—S(═O)₂—OH or the chemical structure —R₁—(S═O)—OH, where in either structure —R₁ represents a carbon chain covalently bound to the subject polymer. The hydroxyl group in the organosulfur acid may also be in dehydrogenated —(O—) ionic form. The organosulfur acid moiety may further be in the form of an organosulfur acid salt, in the form of an anhydride corresponding to a diorganosulfur acid, in an esterified form, or in the form of an organosulfur acid halide. An organosulfur acid halide substitutes a hydroxyl group by a halogen. Common names for examples of types of nucleophilic organosulfur moieties include organosulfonates, organosulfates, metal organosulfates, organosulfuric acids, and organosulfonic acids. The nucleophilic moieties selected from carboxylic acids, organophosphorus acids, organosulfur acids, and nitrocellulose may be further substituted by, in addition to moieties already designated in the above formulas and listings, one or more halogens, hydroxyl groups, and alkyl, alkenyl and alkynyl moieties. The terms alkyl, alkenyl and alkynyl include, as non-limiting examples, moieties having 1-20 carbon atoms. The terms “aryl”, “phenyl” and “benzyl” are synonymous and designate one or more phenyl groups, which may be conjugated, un-conjugated, fused, or otherwise bonded, and may or may not be substituted. As non-limiting examples, a “phenyl” group may include 1-5 benzene rings. In addition to nitrocellulose, other non-explosive organonitrogen acids if available, having chemical structures analogous to those of the other nucleophilic moieties discussed above in which carbon, phosphorus or sulfur is substituted by nitrogen, may also be utilized. The polymer-bound moieties are described as “nucleophilic” in their capacity as electron-sharing or electron-donating or electron-complexing groups in molecular bonding. Describing the nucleophilic moieties as “polymer-bound” means that the nucleophilic moieties are covalently bonded to the subject polymer by a carbon chain.

The article 100 additionally includes a light-reflective layer 114 over the primer layer 108. The light-reflective layer 114 has a third posterior surface 116 and a third anterior surface 118. The third posterior surface 116 of the light-reflective layer 114 faces the second anterior surface 112 of the primer layer 108. The third anterior surface 118 of the light-reflective layer 114 is optically smooth. The light-reflective layer 114 has a third composition including a metal element. The primer layer 108 and the light-reflective layer 114 are molecularly bonded together. The nucleophilic moieties at the second anterior surface 112, for example, selected from carboxylic acids, organophosphorus acids, organosulfur acids, nitrocellulose, and a mixture of two or more of the foregoing, are available for molecular bonding with metal ions, atoms and molecules of the third composition during formation of the light-reflective layer 114 as discussed below. The article 100 may, for example, include a bonding interface 120, constituting a transition region formed by interaction of the second and third compositions, formed by the second anterior surface 112 and the third posterior surface 116. The bonding interface 120 includes a reaction product of the polymer-bound nucleophilic moiety from the second composition and the metal element from the third composition. As an example, the reaction product at the bonding interface 120 may include a salt that includes the metal element and the polymer-bound nucleophilic moiety. It is understood throughout this specification by those skilled in the art that the term “reaction product” denotes the product of a chemical reaction resulting in the formation of a covalent or ionic atomic bond. Viewed from the direction of the arrow 121, for example, the article 100 may have a selected shape and dimensions. As examples, such a selected shape may be round, elliptical, rectangular, or have another polygonal, rectilinear or irregular shape; and such dimensions may be determined based on end-utilization for the article 100.

It is understood throughout this specification by those skilled in the art that when a layer (or interface or substrate or transition region or the like) is referred to as being “on” or “over” another layer, that layer may be directly or actually on (or over) the other layer or, alternatively, one or more intervening layers may also be present. It is further understood that when a layer is referred to as being “on” or “over” another layer, that layer may cover the entire surface of the other layer or only a portion of the surface of the other layer. It is additionally understood throughout this specification by those skilled in the art that terms such as “formed on” are not intended to introduce any limitations relating to particular methods of material transport, deposition, fabrication, surface treatment, or physical, chemical or ionic bonding or interaction.

It is understood throughout this specification by those skilled in the art that a light-reflective surface is deemed to be optically smooth if the surface satisfies the Rayleigh criterion, so that d<λ/(8 cos θ), where d is the surface roughness (root-mean-square roughness height), λ is the wavelength of the incident illumination (spanning the visible light spectrum), and θ is the angle of incidence of this illumination, where θ is within a range of between about 20 degrees and about 60 degrees from the direction normal to the surface plane. An article as disclosed in this specification may be tested for optical smoothness by utilizing ASTM D-2457-03 “Standard Test Method for Specular Gloss of Plastic Films and Solid Plastics” (2007), the entirety of which is incorporated by reference into this specification.

In an example, the polymer-bound nucleophilic moiety in the second composition that is selected from carboxylic acids, organophosphorus acids, organosulfur acids, nitrocellulose, and a mixture of two or more of the foregoing, may be bound to the polymer of the second composition. In another example, the second composition may include, in addition to the polymer, an interpenetrating polymer network. An interpenetrating polymer network is a polymer network that interpenetrates with but is not copolymerized with the polymer of the second composition. As a further example, the polymer-bound nucleophilic moiety in the second composition that is selected from carboxylic acids, organophosphorus acids, organosulfur acids, nitrocellulose, and a mixture of two or more of the foregoing, may be bound to the interpenetrating polymer network. The second composition may include as another example, bound to the polymer and bound to an interpenetrating polymer network, one or more nucleophilic moieties selected from carboxylic acids, organophosphorus acids, organosulfur acids, nitrocellulose, and a mixture of two or more of the foregoing. The polymer, or the interpenetrating polymer network, or both, may for example include chemically labile polymer-bound nucleophilic moieties, available for molecular bonding, selected from carboxylic acids, organophosphorus acids, organosulfur acids, nitrocellulose, and a mixture of two or more of the foregoing.

The second composition may include, for example, a polymer-bound carboxylic acid nucleophilic moiety. As examples, such a polymer-bound carboxylic acid nucleophilic moiety may correspond to a carboxylic acid monomer selected from C₃-C₂₂ monocarboxylic acids, C₂-C₁₂ dicarboxylic acids, anhydrides of a C₄-C₁₂ dicarboxylic acid, corresponding esters, acid halides, and mixtures of two or more of the foregoing. Amino acids including a carboxylic acid moiety, as further examples, may also be utilized.

It is understood throughout this specification by those skilled in the art that by indicating that a moiety in the second composition having a polymer-bound nucleophilic moiety may correspond to a particular carboxylic acid monomer, applicants designate a reaction product resulting from polymerization of that monomer in forming the second composition. That reaction product may include the polymer-bound nucleophilic moiety including the carboxylic acid group in a chemically labile unreacted form, available for molecular bonding. It is understood throughout this specification by those skilled in the art that in general a designation of a moiety in a polymerized composition as corresponding to a particular monomer likewise designates a reaction product resulting from polymerization of that monomer in forming the polymerized composition. It is understood throughout this specification by those skilled in the art that designations of a monomer also include oligomers, pre-polymers and the like having chemical structures that correspond to and that result from polymerization reactions involving such monomers. Further, throughout this specification, designations of a polymer are understood by those skilled in the art to also include co-polymers, and polymers having an interpenetrating polymer network.

Designation of a C₃-C₂₂ monocarboxylic acid, as an example, indicates a monocarboxylic acid having between three (3) and twenty-two (22) carbon atoms. It is understood throughout this specification by those skilled in the art that a designation of a carboxylic acid also includes, as examples, corresponding polycarboxylic acids, corresponding anhydrides, corresponding acid halides, and corresponding partially- or completely-esterified polycarboxylic acids. It is further understood throughout this specification by those skilled in the art that a designation of a monomer or polymer includes corresponding substituted monomers or polymers having substituents including, as examples, substituents selected from halogens, hydroxyl groups, and alkyl, alkenyl and alkynyl moieties.

As further examples where the second composition may include a polymer-bound carboxylic acid nucleophilic moiety, the nucleophilic moiety may correspond to as examples, a carboxylic acid or dicarboxylic acid monomer or an acid halide monomer or an anhydride corresponding to a dicarboxylic acid monomer, or a corresponding ester, or a mixture of two or more of the foregoing. Examples include acetic acid, acrylic acid, methacrylic acid, crotonic acid, vinyl acetic acid, acryloxypropionic acid, maleic acid, itaconic acid, mesaconic acid, fumaric acid, malic acid, tartaric acid, citraconic acid, phthalic acid, malonic acid, succinic acid, glutaric acid, adipic acid, pimelic acid, suberic acid, azelaic acid, sebacic acid, isophthalic acid, terephthalic acid, myristoleic acid, palmitoleic acid, oleic acid, linoleic acid, trimellitic acid, and anhydrides corresponding to dicarboxylic acids, such as maleic anhydride, itaconic anhydride, and phthalic anhydride, trimellitic anhydride, acetic anhydride, acrylic anhydride, and mixtures of two or more of the foregoing. In further examples where the second composition may include a polymer-bound carboxylic acid nucleophilic moiety, the nucleophilic moiety may correspond to one or more carboxylic acid monomers having the formula, CH₃(CH₂)ₙCH═CHCO₂H, where n represents an integer within a range of between 1 and 16.

The second composition of the primer layer 108 may, for example, include a moiety corresponding to a polymerized first monomer, and also a moiety corresponding to a polymerized second monomer including a polymer-bound nucleophilic moiety selected from carboxylic acids, organophosphorus acids, organosulfur acids, nitrocellulose, and mixtures of two or more of the foregoing. The second composition of the primer layer 108 may, as an example, include chemically labile polymer-bound nucleophilic moieties available for molecular bonding, selected from carboxylic acids, organophosphorus acids, organosulfur acids, nitrocellulose, and a mixture of two or more of the foregoing. The second composition may, for example, be formed by a process including ultraviolet light-induced polymerization. The second composition may include a moiety corresponding to a polymerized ethylenically unsaturated monomer. It is understood by those skilled in the art throughout this specification that the term “unsaturated” means that the subject monomer or polymer includes one or more pairs of two carbon atoms sharing a double or triple covalent bond. Ethylenically unsaturated monomers may be suitable, as another example, for free-radical polymerization in forming the second composition. Free-radical polymerization may be initiated and catalyzed, as an example, by ultraviolet light-induced activation of an initiator. Such ethylenically unsaturated monomers may include, for example, a monomer having a carbonyl group including an alpha-beta-ethylenically unsaturated moiety, such as a vinyl group, susceptible to free-radical polymerization. It is understood throughout this specification by those skilled in the art that other ethylenically unsaturated monomers that are suitable for ultraviolet light-induced polymerization or free-radical polymerization may be utilized.

In another example, the second composition may include a polymer having a moiety corresponding to a mono- or multi-functional acrylate monomer. Such an acrylate monomer may include a polymer-bound nucleophilic moiety selected from carboxylic acids, organophosphorus acids, organosulfur acids, nitrocellulose, and a mixture of two or more of the foregoing. The second composition may include such a polymer-bound nucleophilic moiety in chemically labile, unreacted form available for molecular bonding. Alternatively, for example, the second composition may include such a polymer-bound nucleophilic moiety in addition to a polymer having a moiety corresponding to a mono- or multi-functional acrylate monomer. In examples, the second composition may include a polymer having a moiety corresponding to a mono- or multi-functional acrylate monomer selected from acrylic acid esters, alkyl acrylic acid esters, aryl acrylic acid esters, acrylic acid alkyl esters, alkyl acrylic acid alkyl esters, aryl acrylic acid alkyl esters, and mixtures of two or more of the foregoing. Particular acrylate monomers that may be so utilized include, as examples, methyl acrylate, methyl methacrylate, ethyl acrylate, ethyl methacrylate, n-propyl acrylate, n-propyl methacrylate, n-isopropyl acrylate, n-isopropyl methacrylate, n-butyl acrylate, n-butyl methacrylate, isobutyl acrylate, isobutyl methacrylate, tert-butyl acrylate, tert-butyl methacrylate, 2-ethylhexyl acrylate, 2-ethylhexyl methacrylate, hydroxyethyl acrylate, hydroxyethyl methacrylate, hydroxypropyl acrylate, hydroxypropyl methacrylate, dimethylaminoethyl acrylate, dimethylaminoethyl methacrylate, phosphoethyl acrylate, phosphoethyl methacrylate, cyclohexyl methacrylate, neopentyl methacrylate, isobornyl methacrylate, 3,3,5-trimethylcyclohexyl methacrylate, stearyl methacrylate, and mixtures of two or more of the foregoing. Further, the second composition may include a copolymer of an acrylate monomer and another monomer. As examples, the second composition may include a mono- or multi-acrylate-functional polymer selected from epoxy acrylates, urethane acrylates, polyester acrylates, polyether acrylates, silicone acrylates, acrylic acrylates, cellulose acetate butyrates, fatty acid acrylates, poly(ethylene glycol) acrylates, and mixtures of two or more of the foregoing.

The second composition of the primer layer 108 may further include, for example, a moiety corresponding to a multi-functional acrylate monomer suitable for cross-linking the second composition. By “multifunctional” is meant that the acrylate monomer has two or more acrylate functional groups available for molecular bonding. As examples of such multi-functional acrylate monomers, pentaerythritol tetraacrylate, dipentaerythritol pentaacrylate, dipentaerythritol hexaacrylate, ethoxylated trimethylolpropane triacrylate, ethoxylated pentaerythritol triacrylate, propoxylated glyceryl triacrylate, trimethylolpropane triacrylate, pentaerythritol triacrylate, propoxylated trimethylolpropane triacrylate, trimethylolpropane trimethacrylate, tris(2-hydroxyethyl)isocyanurate triacrylate, and mixtures of two or more of the foregoing may be utilized.

Where pentaerythritol tetraacrylate is utilized as a multi-functional acrylate monomer in forming the second composition, the second composition may include fully-crosslinked moieties having the following formula where each R denotes a different carbon atom of the polymer:

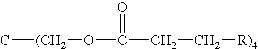

Where dipentaerythritol pentaacrylate is utilized as a multi-functional acrylate monomer in forming the second composition, the second composition may include fully cross-linked moieties having the following formula where each R denotes a different carbon atom of the polymer:

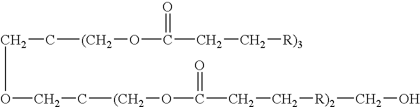

In another example, the second composition may include a poly(acrylamide) corresponding to an acrylamide monomer. Such an acrylamide monomer may include a polymer-bound nucleophilic moiety selected from carboxylic acids, organophosphorus acids, organosulfur acids, nitrocellulose, and a mixture of two or more of the foregoing. The second composition may include such a polymer-bound nucleophilic moiety in chemically labile, unreacted form available for molecular bonding. Alternatively, for example, the second composition may include such a polymer-bound nucleophilic moiety in addition to a polymer having a moiety corresponding to an acrylamide monomer. As examples, the acrylamide monomer may include N-methylol acrylamide, acrylamide, methacrylamide, N-tert-butylacrylamide, N-methylacrylamide, N,N-dimethyl acrylamide, or a mixture of two or more of the foregoing.

The second composition may include, as additional examples, a polymer corresponding to a monomer selected from 1,3-butadiene, isoprene, acrylonitrile, methacrylonitrile, styrene, hydroxylated styrene, vinyl acetate, vinyl propionate, vinyl n-butyrate, vinyl laurate, vinyl stearate, divinylbenzene, 2-vinylnaphthalene, 9-vinylanthracene, methylstyrene, chlorostyrene, dimethylstyrene, 4-vinyl-biphenyl, vinyltoluene, triallyl cyanurate, dimethyl maleate, maleic acid n-butyl ester, dihydrodicyclopentadienyl acrylate, succinic acid, adipic acid, ethylene glycol, 1,4-butanediol, styrenesulfonic acid, diallyl ether, methane sulfonic acid, p-toluene sulfonic acid, vinylsulfonic acid, 2-acrylamido-2-methylpropanesulfonic acid, N-vinyl pyrrolidone, N-vinylformamide, N-vinylimidazole, gelatin, and mixtures of two or more of the foregoing.

As an example, the second composition may include MS0305, an acid-functional ultraviolet light-curable coating composition that is commercially available from Seed Co., Ltd., having a business address at 117-1 Kano Okegawa-Shi, Saitama-Ken, Japan. In another example, the second composition may include DD-714, an ultraviolet-curable acrylate, including a carboxylic acid—multifunctional acrylate, the multifunctionality including dipentaerythritol hexaacrylate, the composition also including 5% by weight DAROCUR-1173 photoinitiator, and a solvent blend including N-butanol and toluene. Another example of a photoinitiator that may be utilized is IRGACURE 184, commercially available from CIBA Specialty Chemicals, 540 White Plains Road, Tarrytown, N.Y. 10591 U.S.A.

The first composition of the substrate 102 may include, for example, a polymer having a moiety capable of molecular bonding with a polymer-bound nucleophilic moiety selected from carboxylic acids, organophosphorus acids, organosulfur acids, nitrocellulose, and a mixture of two or more of the foregoing. The substrate 102 and the primer layer 108 may, for example, be molecularly bonded together. As another example, the article 100 may include a second bonding interface 122, constituting a transition region formed by interaction of the first and second compositions of the first anterior surface 106 and the second posterior surface 110. The second bonding interface 122 may include a reaction product of the first composition polymer with a polymer-bound nucleophilic moiety in the second composition selected from carboxylic acids, organophosphorus acids, organosulfur acids, nitrocellulose, and a mixture of two or more of the foregoing. For example, the first composition may include chemically labile hydroxyl, amino, carbonyl, alkoxy, or unsaturated moieties available for molecular bonding with such a polymer-bound nucleophilic moiety. The first composition may include, as examples, an engineering polymer selected from thermoplastic polymers, thermosetting polymers, and mixtures. As additional examples, the first composition may include a poly(olefin), poly(vinyl chloride), poly(styrene), poly(fluoroethylene), poly(acrylate), poly(vinyl acid ester), poly(carbonate), poly(ester), poly(urethane), poly(amide), poly(unsaturated ester), poly(acrylonitrile butadiene styrene), poly(styrene acrylonitrile), or a mixture of two or more of the foregoing. As an example of a poly(acrylate), poly(methylmethacrylate) may be utilized. As an example of a poly(carbonate), poly(butylmethylcarbonate) may be utilized. The first composition may include a filler for purposes of extending, strengthening, or otherwise changing the performance capabilities of the first composition. Examples of fillers include wood, fiberglass, other fibrous materials such as poly(propylene) fibers, Kevlar® aramid fibers, or carbon fibers, pigment, and mixtures of two or more of the foregoing. A poly(carbonate) designated as LS2-111 commercially available from General Electric Company, having a business address at 1 Plastics Avenue, Pittsfield, Mass. 01201 U.S.A., may be utilized. Another poly(carbonate) designated as Calibre 300EP-22 commercially available from Dow Chemical International, having a business address at 2030 Dow Center, Midland, Mich. 48674 U.S.A., may be utilized. Further, a poly(methylmethacrylate) designated as CM205 commercially available from Chi Mei Corp., having a business address at 59-1 San Chia, Jen Te, Taiwan County, Taiwan R.O.C., may be utilized.

The third composition of the light-reflective layer 114 includes a metal element or alloy suitable to provide an optically smooth light-reflective third anterior surface 118. The third composition may include, for example, a metal element selected from chromium, aluminum, silver, nickel, rhodium, gold, platinum, palladium, and their alloys. It is understood throughout this specification by those skilled in the art that other metals and other elements may be included in the third composition. In further examples, the third composition of the light-reflective layer 114 may include a metal element selected from chromium, aluminum, gold, and their alloys. The polymer-bound nucleophilic moiety in the second composition of the primer layer 108 may, for example, facilitate molecular bonding together of the primer layer 108 and the light-reflective layer 114.

The optically smooth third anterior surface 118 of the light-reflective layer 114 may, for example, have a first contour. The first contour of the optically smooth third anterior surface 118 may be, as examples, planar, convex, or concave. The second anterior surface 112 of the primer layer 108 may have a second contour, as another example. In an example, the first contour of the optically smooth third anterior surface 118 may be substantially congruous with the second contour of the second anterior surface 112 of the primer layer 108. The light-reflective layer 114 may, as an example, be formed by vacuum deposition of the third composition, in one or more deposition forms including atoms, molecules and ions, onto the primer layer 108. This vacuum deposition results in formation of a molecular bond between the primer layer 108 and the light-reflective layer 114. In an example, the vacuum deposition may form a bonding interface 120 including a reaction product of the polymer-bound nucleophilic moiety from the second composition and the metal element from the third composition. As an example, the reaction product at the bonding interface 120 may include a salt that includes the metal element and the polymer-bound nucleophilic moiety. In another example, the polymer-bound nucleophilic moiety in the second composition may facilitate molecular bonding with the third composition of the light-reflective layer 114 at the bonding interface 120. The third composition, as facilitating molecular bonding at the bonding interface 120 with the polymer-bound nucleophilic moiety in the second composition, may as another example be selected to include chromium, aluminum, gold, or their alloys.

Light traveling on a path in the direction of the arrow 123 may be reflected off of the third anterior surface 118 of the light-reflective layer 114 in the direction of the arrow 125, for example. The light-reflective layer 114 may have an average solar reflectance, for example, within a range of between about 50% and about 98% of light. It is understood by those skilled in the art throughout this specification that solar reflectance is the average fraction of incident solar energy that is reflected by a surface such as the third anterior surface 118 of the light-reflective layer 114. Solar reflectance may be determined by utilizing spectrophotometric measurements at different wavelengths. The average reflectance is then determined by an averaging process, using a standard solar spectrum. The testing procedure disclosed in SAE J964 “Recommended Practice for Measuring Haze and Reflectance of Mirrors” (1998), the entirety of which is incorporated by reference into this specification, may be utilized.

The article 100 may include a substrate 102, a primer layer 108, and a light-reflective layer 114 each having a thickness in the directions of the arrow 127 that is at least adequate for a contemplated end-utilization of the article 100. For example, the substrate 102 may serve to support the primer layer 108 and the light-reflective layer 114 and to provide overall structural integrity to the article 100. The substrate 102 may have an average thickness defined as the distance between the first posterior and anterior surfaces 104, 106 in the directions of the arrow 127, for example, within a range of between about 2 millimeters and about 5 millimeters. In other examples, the substrate 102 may have an average thickness defined as the distance between the first posterior and anterior surfaces 104, 106 in the directions of the arrow 127, which is as small as 1 millimeter or is less than 1 millimeter. In further examples, the substrate 102 may have an average thickness defined as the distance between the first posterior and anterior surfaces 104, 106 in the directions of the arrow 127, which is as large as 10 millimeters or which is 1 centimeter or larger.

As another example, the light-reflective layer 114 may serve to reflect light, such as in the directions of the arrows 123, 125 discussed earlier. The optically smooth third anterior surface 118 of the light-reflective layer 114 may function as an optical reflective mirror, and the article 100 may be end-utilized, for example, as a mirror. The light-reflective layer 114 may have a thickness defined as the distance between the third posterior and third anterior surfaces 116, 118 in the directions of the arrow 127, for example, at least sufficiently large to achieve a selected solar reflectance. For example, the light-reflective layer 114 may have an average thickness defined as the distance between the third posterior and third anterior surfaces 116, 118 in the directions of the arrow 127, within a range of between about 300 Angstroms and about 10,000 Angstroms. As another example, the light-reflective layer 114 may have an average thickness defined as the distance between the third posterior and third anterior surfaces 116, 118 in the directions of the arrow 127, within a range of between about 300 Angstroms and about 2,000 Angstroms. In an additional example, the light-reflective layer 114 may have an average thickness defined as the distance between the third posterior and third anterior surfaces 116, 118 in the directions of the arrow 127, within a range of between about 300 Angstroms and about 1,000 Angstroms. As a further example, the light-reflective layer 114 may have an average thickness defined as the distance between the third posterior and third anterior surfaces 116, 118 in the directions of the arrow 127, within a range of between about 300 Angstroms and about 600 Angstroms.

The primer layer 108 may have an average thickness defined as the distance between the second posterior and anterior surfaces 110, 112 in the directions of the arrow 127, at least sufficiently large to effectively form the second bonding interface 122. The primer layer 108 may have an average thickness defined as the distance between the second posterior and anterior surfaces 110, 112 in the directions of the arrow 127, for example, within a range of between about 1 micron and about 50 microns, or within a range of between about 3 microns and about 5 microns, or within a range of between about 4 microns and about 5 microns.

As an example, an article 100 may be sufficiently robust for utilization in a selected end-use without any protection against physical damage or degradation. An article 100 may, in another example, be protected from physical damage by mounting the article 100 in an enclosure placing the light-reflective layer 114 behind an optically-transparent window. Alternatively, an article 100 may include a protective layer (not shown), as discussed below.

The article 100 may include or form a part of myriad articles and apparatus having a reflective or shiny, chromed appearance, such as accent panels of portable devices including personal digital assistants, grilles, panels and insignia for vehicles and for other devices and apparatus. As further examples, the article 100 may include or form a part of mirrors, architectural detailing, sales displays, personal accessories such as jewelry and sunglasses, and articles or apparatus in a wide array of other end-utilization applications where a reflective or shiny metallic surface is needed. Examples of mirrors include mirrors for automobiles, motorcycles, trucks, bicycles, other land vehicles, boats, ships, and aircraft, as well as mirrors for stationary or industrial end-uses. The articles 100 may include complex shapes, detailing, surfaces conforming to surfaces of other articles (not shown), and other structural features taking advantage of the capability of forming the articles 100 to have a wide variety of dimensions, contours, and other selected structural specifications.

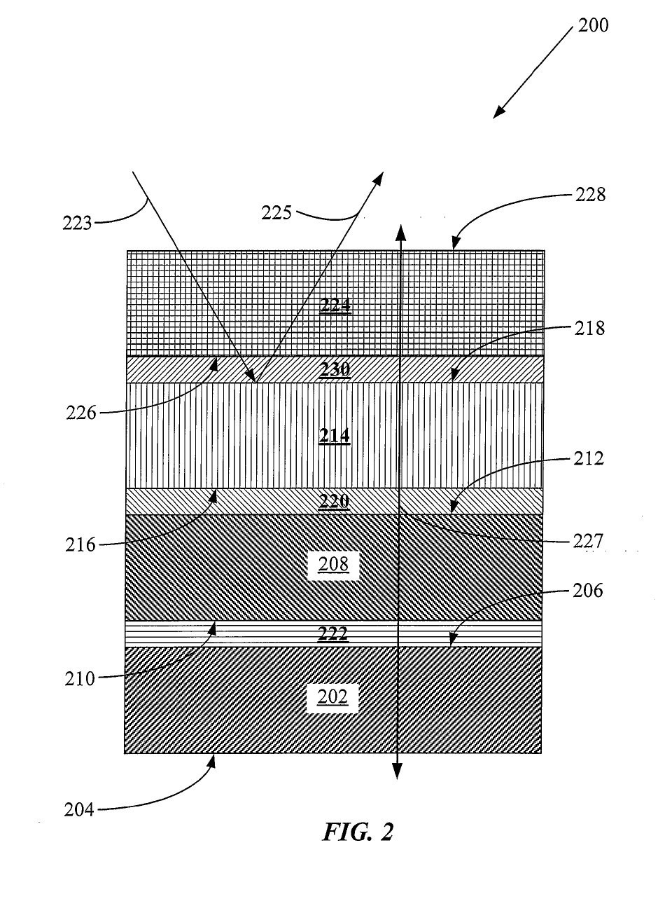

FIG. 2 is a cross-sectional side view showing an example of another implementation of an article 200. The article 200 includes a substrate 202 having a first posterior surface 204 and a first anterior surface 206. The substrate 202 has a first composition including a polymer. The article 200 also includes a primer layer 208 over the substrate 202. The primer layer 208 has a second posterior surface 210 and a second anterior surface 212. The second posterior surface 210 of the primer layer 208 faces the first anterior surface 206 of the substrate 202. The primer layer 208 has a second composition including a polymer, and a polymer-bound nucleophilic moiety selected from carboxylic acids, organophosphorus acids, organosulfur acids, nitrocellulose, and a mixture of two or more of the foregoing. The article 200 additionally includes a light-reflective layer 214 over the primer layer 208. The light-reflective layer 214 has a third posterior surface 216 and a third anterior surface 218. The third posterior surface 216 of the light-reflective layer 214 faces the second anterior surface 212 of the primer layer 208. The third anterior surface 218 of the light-reflective layer 214 is optically smooth. Light traveling on a path in the direction of the arrow 223 may be reflected off of the third anterior surface 218 of the light-reflective layer 214 in the direction of the arrow 225, for example. The light-reflective layer 214 may have an average solar reflectance, for example, within a range of between about 50% and about 98% of light over a visible spectrum. The light-reflective layer 214 has a third composition including a metal element. The primer layer 208 and the light-reflective layer 214 are molecularly bonded together. As an example, the article 200 may include a bonding interface 220, constituting a transition region formed by interaction of the second and third compositions of the second anterior surface 212 and the third posterior surface 216. The bonding interface 220 includes a reaction product of the polymer-bound nucleophilic moiety from the second composition and the metal element from the third composition. As an example, the reaction product at the bonding interface 220 may include a salt that includes the metal element and the polymer-bound nucleophilic moiety.

The first composition of the substrate 202 may be determined as discussed above in connection with the first composition of the substrate 102 in the article 100. The first composition of the substrate 202 may include, for example, a polymer having a moiety capable of molecular bonding with a polymer-bound nucleophilic moiety selected from carboxylic acids, organophosphorus acids, organosulfur acids, nitrocellulose, and a mixture of two or more of the foregoing. The substrate 202 and the primer layer 208 may, for example, be molecularly bonded together. As another example, the article 200 may include a second bonding interface 222, constituting a transition region formed by interaction of the first and second compositions of the first anterior surface 206 and the second posterior surface 210. The second bonding interface 222 may include a reaction product of the first composition polymer with a polymer-bound nucleophilic moiety in the second composition selected from carboxylic acids, organophosphorus acids, organosulfur acids, nitrocellulose, and a mixture of two or more of the foregoing. For example, the first composition may include chemically labile hydroxyl, amino, carbonyl, alkoxy, or unsaturated moieties available for molecular bonding with such a polymer-bound nucleophilic moiety. The second composition of the primer layer 208 may be determined as discussed above in connection with the second composition of the primer layer 108 in the article 100. The third composition of the light-reflective layer 214 may be determined as discussed above in connection with the third composition of the light-reflective layer 114 in the article 100. The entirety of the above discussions of the first, second and third compositions of the substrate 102, the primer layer 108, and the light-reflective layer 114 of the article 100, and of the thicknesses, functions, bonding interactions, structures, and formation of such compositions, substrate and layers, are fully applicable to and are incorporated by reference into this discussion of the first, second and third compositions of the substrate 202, the primer layer 208, and the light-reflective layer 214 in the article 200.

The article 200 further includes a protective layer 224 over the light-reflective layer 214. The protective layer 224 has a fourth posterior surface 226 and a fourth anterior surface 228. The fourth posterior surface 226 of the protective layer 224 faces the third anterior surface 218 of the light-reflective layer 214. The light-reflective layer 214 and the protective layer 224 may, for example, be molecularly bonded together.

The protective layer 224 has a fourth composition that may include an organic composition, an inorganic composition, or both. As examples, the fourth composition may include an inorganic composition such as diamond-like carbon (“DLC”), aluminum nitride, silicon dioxide, C₂N₂, or a mixture of two or more of the foregoing. As further examples, the fourth composition may include an organic composition such as a poly(olefin), poly(vinyl chloride), poly(styrene), poly(fluoroethylene), poly(acrylate), poly(vinyl acid ester), poly(carbonate), poly(ester), poly(urethane), poly(amide), poly(unsaturated ester), poly(acrylonitrile butadiene styrene), poly(styrene acrylonitrile), poly(siloxane) or a mixture of two or more of the foregoing and/or including one or more inorganic compositions. In an example, the fourth composition may include an ultraviolet light—curable acrylate-containing composition having a grade designation of UVX0650V1 commercially available from Red Spot Paint & Varnish Co., Inc., having a business address at 1107 East Louisiana St., Evansville, Ind. 47711 U.S.A.

In another example, the fourth composition may include diamond-like carbon (“DLC”). It is understood throughout this specification by those skilled in the art that the term “diamond-like carbon” or “DLC” broadly includes amorphous carbon-containing compositions having an sp³ carbon atomic bond concentration within a range of between about 15% and about 90% and commonly known as diamond-like carbon, including those diamond-like carbon compositions known as ta-C, ta-C:H, DLCH, PLCH, and GLCH. A ta-C composition does not contain hydrogen and has a C—C sp³ carbon atomic bond concentration greater than 60% and up to about 90%. As an example, a ta-C composition may include a C—C sp³ carbon atomic bond concentration of up to about 90%. A ta-C composition having a C—C sp³ carbon atomic bond concentration greater than about 90% may be utilized, provided that resulting surface stresses are not great enough to impair structural integrity. A PLCH composition has greater than 40 atomic % hydrogen and an sp³ carbon atomic bond concentration up to 70%. A DLCH composition includes 20-40 atomic % hydrogen and sp³ carbon atomic bond concentration up to 70%. A GLCH composition includes less than 20 atomic % hydrogen and less than 20 atomic % sp³ carbon atomic bond concentration. A ta-C:H composition includes 25-35 atomic % hydrogen and an sp³ carbon atomic bond concentration up to 70%. These diamond-like carbon compositions may also include one or more metal elements such as silicon, tungsten, titanium, mixtures of two or more of the foregoing, or other metal or non-metal elements. As examples, Diamonex® Diamond-like Carbon coatings, commercially available from the Diamonex Products Division of Morgan Crucible Company PLC having a business address at 7331 William Avenue, Allentown, Pa. 18106, may be utilized. Where included in the fourth composition of the protective layer 224, diamond-like carbon having an sp³ carbon atomic bond concentration within a range of between about 50% and about 90% may, for example, be utilized.

An sp³ carbon atomic bond concentration of the protective layer 224 may be quantitatively determined, for example, utilizing Raman spectra of the protective layer 224 employing visible and ultra-violet wavelengths. See, for example, Gilkes, K. W. R. et al., “Direct Quantitative Detection of the sp³ Bonding in Diamond-Like Carbon Films Using Ultra-violet and Visible Raman Spectroscopy”, Journal Applied Physics, Vol. 87, No. 10, pp. 7283-7289 (May 15, 2000), the entirety of which is incorporated by reference into this specification.

In an example, the light-reflective layer 214 and the protective layer 224 may be molecularly bonded together. The article 200 may include a third bonding interface 230, constituting a transition region formed by interaction of the third and fourth compositions of the third anterior surface 218 and the fourth posterior surface 226. The third bonding interface 230 includes a reaction product of the third composition metal element with the fourth composition. For example, the third bonding interface 230 may include a reaction product of a metal element in the third composition of the light-reflective layer 214 with diamond-like carbon included in the fourth composition of the protective layer 224.

The protective layer 224 may have a thickness in the directions of the arrow 227 that is at least adequate to physically protect the article 200 from damage and degradation in a contemplated end-utilization of the article 200. The thickness as well as the fourth composition of the protective layer 224 may be selected as suitable to protect the article 200 from damage and degradation caused by external forces including, for example, weather and impacts. Such degradation may include, as examples, erosion, corrosion, and intrusion by fluids. For example, the protective layer 224 may have an average thickness, defined as the distance between the fourth posterior and anterior surfaces 226, 228 in the directions of the arrow 227, within a range of between about 100 Angstroms and about 1000 Angstroms.

In examples where the protective layer 224 includes diamond-like carbon, the protective layer 224 may have an average thickness defined as the distance between the fourth posterior and anterior surfaces 226, 228 in the directions of the arrow 227 that is within a range of between about 100 Angstroms and about 1000 Angstroms, and an sp³ carbon atomic bond concentration within a range of between about 15% and about 60%. In another example, the protective layer 224 may have a thickness within a range of between about 50 Angstroms and about 500 Angstroms, and an sp carbon atomic bond concentration within a range of between about 70% and about 80%.

The protective layer 224 may, for example, need to have a selected abrasion resistance to effectively protect the article 200 from damage and degradation in a contemplated end-utilization. Abrasion resistance is expressed as a delta change in light scattering under the ASTM D1044-99 test protocol of less than about 7%, or within a range of between about 3% and about 7%. The entirety of ASTM D1044-99 “Standard Test Method for Resistance of Transparent Plastics to Surface Abrasion” (2007) is incorporated by reference into this specification.

In examples, the article 200 may include or form a part of myriad articles and apparatus having a reflective or shiny, chromed appearance, such as accent panels of portable devices including personal digital assistants, grilles, panels and insignia for vehicles and for other devices and apparatus. As further examples, the article 200 may include or form a part of mirrors, architectural detailing, sales displays, personal accessories such as jewelry and sunglasses, and articles or apparatus in a wide array of other end-utilization applications where a reflective or shiny metallic surface is needed. Examples of mirrors include mirrors for automobiles, motorcycles, trucks, bicycles, other land vehicles, boats, ships, and aircraft, as well as mirrors for stationary or industrial end-uses. The articles 200 may include complex shapes, detailing, surfaces conforming to surfaces of other articles (not shown), and other structural features taking advantage of the capability of forming the articles 200 to have a wide variety of dimensions, contours, and other selected structural specifications.

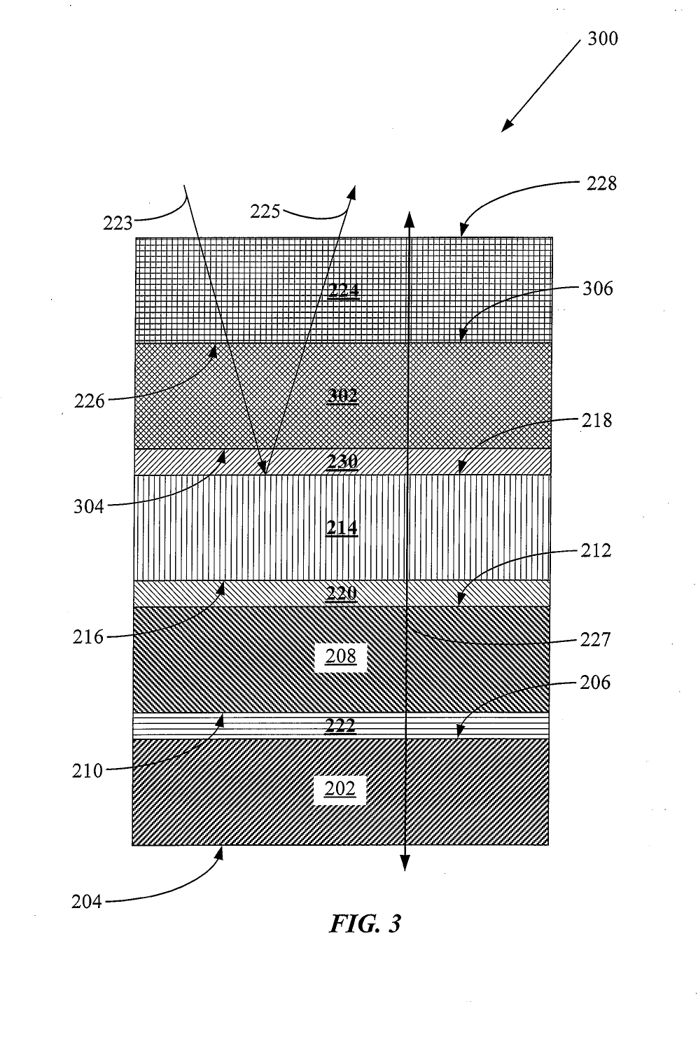

FIG. 3 is a cross-sectional side view showing another example 300 of the article 200 shown in FIG. 2. In this example, the article 200 has been modified to include a tie layer 302 interposed between the light-reflective layer 214 and the protective layer 224. As an example, the tie layer 302 may form a stronger molecular bond between a light-reflective layer 214 having a selected third composition and a protective layer 224 having a selected fourth composition than may alternatively be formed directly between such layers. The tie layer 302 has a fifth posterior surface 304 and a fifth anterior surface 306. The fifth posterior surface 304 of the tie layer 302 faces the third anterior surface 218 of the light-reflective layer 214. The fifth anterior surface 306 of the tie layer 302 faces the fourth posterior surface 226 of the protective layer 224. The tie layer 302 has a fifth composition including an inorganic compound, an organic metal-containing compound, or a mixture of the foregoing. For example, the fifth composition may include a silicon oxide, alumina, aluminum silicate, zirconium silicate, aluminum nitride, titanium oxide, zirconium oxide, alkyl titanate, alkyl zirconate, siloxane, alkyl silane, alkoxy silane, amino silane, or a mixture of two or more of the foregoing. Tetraalkyl titanates and zirconates have the formulas Ti(OR)₄ and Zr(OR)₄ respectively, where R designates an alkyl group. Such an alkyl group may, for example, include 1-12 carbon atoms, may be halogenated, and may be saturated or unsaturated. For example, the fifth composition may include a titanate, or an analogous zirconate, selected from tetraethyl titanate, tetra-n-propyl titanate, tetraisopropyl titanate, tetraisobutyl titanate, tetra-n-butyl titanate, tetrakis(2-ethylhexyl)titanate, and a mixture of two or more of the foregoing.

The example article 300 shown in FIG. 3 includes a molecular bond between the light-reflective layer 214 and the protective layer 224. For example, the article 300 may include a third bonding interface 230 as discussed in connection with FIG. 2. In this example 300 of the article 200, the third bonding interface 230 constitutes a transition region formed by interaction of the third and fifth compositions of the third anterior surface 218 of the light-reflective layer 214 and the fifth posterior surface 304 of the tie layer 302. The third bonding interface 230 includes a reaction product of the third composition metal element with the fifth composition. For example, the third bonding interface 230 may include a reaction product of a metal element in the third composition of the light-reflective layer 214 with the fifth composition of the tie layer 302 including an inorganic compound, an organic metal-containing compound, or a mixture of the foregoing.

The tie layer 302 may have an average thickness defined as the distance between the fifth posterior and anterior surfaces 304, 306 in the directions of the arrow 227, at least sufficiently large to effectively form the third bonding interface 230. The tie layer 302 may have an average thickness defined as the distance between the fifth posterior and anterior surfaces 304, 306 in the directions of the arrow 227, for example, within a range of between about 1 micron and about 5 microns.

The tie layer 302 included in the example 300 of the article 200 shown in FIG. 3 may facilitate utilization of a fourth composition for the protective layer 224 either as discussed above in connection with FIG. 2, or that instead or additionally includes a polymer having a polymer-bound nucleophilic moiety selected from carboxylic acids, organophosphorus acids, organosulfur acids, nitrocellulose, and a mixture of two or more of the foregoing. In a further example, the fourth composition so selected may include a polymer having a polymer-bound carboxylic acid nucleophilic moiety. As examples, a silane, siloxane, titanate or zirconate included in the tie layer 302 may form a reaction product with such a polymer-bound nucleophilic moiety included in the protective layer 224. The fourth composition may, as another example, include a polymer having a moiety corresponding to an ethylenically unsaturated monomer. In a further example, the protective layer 224 may have a fourth composition including a polymer having a moiety corresponding to a mono- or multi-functional acrylate monomer. The protective layer 224 may be fabricated, for example, from a fourth composition including monomers as discussed earlier in connection with the second composition for the primer layer 108 shown in FIG. 1. The entirety of the earlier discussion of monomer formulations for the second composition for the primer layer 108 is applicable to formulation of the fourth composition in this example 300 of an article 200, and is incorporated by reference here.

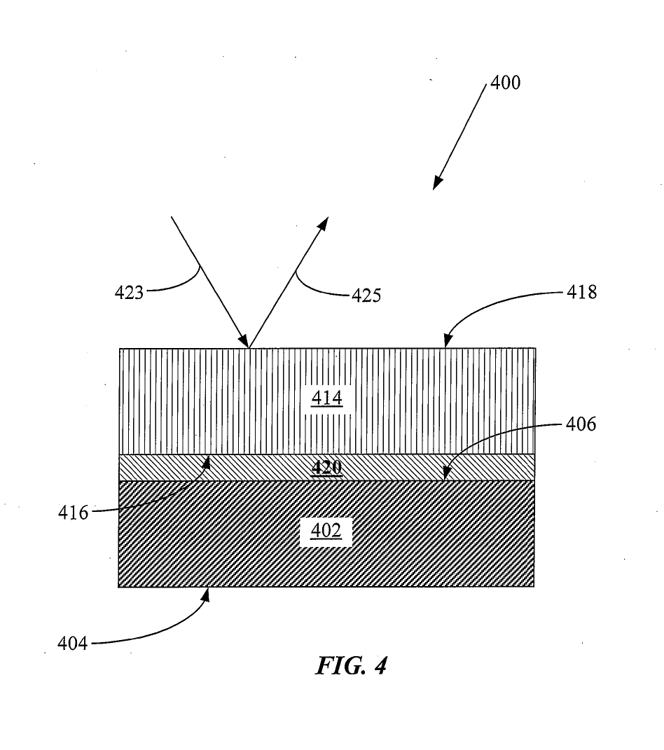

FIG. 4 is a cross-sectional side view showing an example of an additional implementation of an article 400. The article 400 includes a substrate 402 having a first posterior surface 404 and a first anterior surface 406. The substrate 402 has a first composition including a polymer having a polymer-bound nucleophilic moiety selected from carboxylic acids, organophosphorus acids, organosulfur acids, nitrocellulose, and a mixture of two or more of the foregoing. The article 400 additionally includes a light-reflective layer 414 over the substrate 402. The light-reflective layer 414 has a second posterior surface 416 and a second anterior surface 418. The second posterior surface 416 of the light-reflective layer 414 faces the first anterior surface 406 of the substrate 402. The second anterior surface 418 of the light-reflective layer 414 is optically smooth. Light traveling on a path in the direction of the arrow 423 may be reflected off of the second anterior surface 418 of the light-reflective layer 414 in the direction of the arrow 425, for example. The light-reflective layer 414 may have an average solar reflectance, for example, within a range of between about 50% and about 98% of light over a visible spectrum. The light-reflective layer 414 has a second composition including a metal element. The substrate 402 and the light-reflective layer 414 are molecularly bonded together. The article 400 may include a bonding interface 420, constituting a transition region formed by interaction of the first and second compositions of the first anterior surface 406 and the second posterior surface 416. The bonding interface 420 includes a reaction product of the polymer-bound nucleophilic moiety from the first composition and the metal element from the second composition. As an example, the reaction product at the bonding interface 420 may include a salt that includes the metal element and the polymer-bound nucleophilic moiety.

The first composition of the substrate 402 may be determined as discussed above in connection with the second composition of the primer layer 108 in the article 100, provided that the first composition is selected to have suitable engineering strength and rigidity to serve the structural role of the substrate 102 discussed earlier. The first composition of the substrate 402 may include, for example, polylactic acid. As another example, the first composition may include polylactic acid physically blended with poly-D-lactide. The second composition of the light-reflective layer 414 may be determined as discussed above in connection with the third composition of the light-reflective layer 114 in the article 100. The entireties of the above discussions, in connection with the article 100, of the second composition of the primer layer 108 and of the third composition of the light-reflective layer 114, and of the thicknesses, functions, bonding interactions, structures, and formation of such compositions and layers, are fully applicable to and incorporated by reference into this discussion of the first composition of the substrate 402 and the second composition of the light-reflective layer 414 in the article 400.

In another example, the article 400 may further include a protective layer (not shown) over the light-reflective layer 414. The protective layer may have a composition determined as discussed above in connection with the fourth composition of the protective layer 224 in the example 300 shown in FIG. 3 of an article 200. As a further example, the article 400 may also include a tie layer (not shown) interposed between the light-reflective layer 414 and such a protective layer (not shown). The tie layer may have a composition determined as discussed above in connection with the fifth composition of the tie layer 302 in the example 300 of an article 200 shown in FIG. 3. The entireties of the above discussions, in connection with the articles 200, 300 of the fourth composition of the protective layer 224 and of the fifth composition of the tie layer 302, and of the thicknesses, functions, bonding interactions, structures, and formation of such compositions and layers, are fully applicable to and incorporated by reference into this discussion of examples of compositions of a protective layer (not shown) and a tie layer (not shown) that may be included in the article 400.

As explained earlier, an article 100, 200, 300, 400 may include or form a part of myriad articles and apparatus having a reflective or shiny, chromed appearance. The articles 100, 200, 300, 400 may be performance-tested depending on a selected end-utilization. As examples, performance testing may include testing for adhesion of layers, thermal and moisture cycling, abrasion resistance, salt spray resistance, and accelerated weathering. These examples of types of articles and parts of articles 100, 200, 300, 400 may be performance tested as to adhesion of layers, thermal and moisture cycling, abrasion resistance, salt spray resistance, and accelerated weathering by utilizing the following test protocols as will readily be adapted by those skilled in the art for a particular article 100, 200, 300, 400 to be tested. The entireties of the following ASTM test protocols are incorporated into this specification by reference: ASTM D 3359-02 (2006); ASTM D 1044-99 (2007), ASTM D 2457-03 (2007), and ASTM B 117-07 (2007). Further, the entirety of the SAE International J1960 standard is incorporated into this specification by reference.

For example, an article 100, 200, 300 400 may be performance-tested as to adhesion of its substrate and layer(s) together by subjecting the article to Test Method B—Cross-Cut Tape Test, defined in ASTM D 3359-02 (2006). An article 100, 200, 300, 400 disclosed above, as well as each of the article's substrate and layer(s) adhered together at the bonding interface(s) discussed above and shown in FIGS. 1-4 may, for example, generate a 5B adhesion result when tested according to Test Method B.

As another example, an article 100, 200, 300, 400 may be subjected to a thermal and moisture cycling performance test protocol. The following twenty-four hour testing regime may be successively repeated through four cycles, yielding a total testing time of ninety-six hours. The testing regime starts with vertically positioning the article 100, 200, 300, 400 in a humidity chamber at 95-100% relative humidity (“RH”) and a temperature of 38+/−1 degrees Celsius (° C.), for a period of sixteen (16) hours. On removal then from the humidity chamber, the article 100, 200, 300, 400 is immediately placed in a cold box at −40+/−1° C. for a period of four (4) hours. On removal then from the cold box, the article 100, 200, 300, 400 is immediately placed in an oven at 88+/−1° C. and 95-100% relative humidity for a period of four (4) hours. An article 100, 200, 300, 400 disclosed above, as well as each of the article's substrate and layer(s) bonded together at the bonding interface(s) discussed above and shown in FIGS. 1-4 may, for example, after being subjected to this ninety-six hour thermal and moisture cycling performance test protocol, maintain unchanged coloration, maintain bonding adhesion between the substrate and layer(s) of the article, and exhibit less than about 1% degradation of the light-reflective layer's solar reflectance resulting from the thermal and moisture cycling. In an example, an article 100, 200, 300, 400 disclosed above, as well as each of the article's substrate and layer(s) bonded together at the bonding interface(s) discussed above and shown in FIGS. 1-4 may also, after being subjected to this ninety-six hour thermal and moisture cycling performance test protocol, show no visually apparent cracking, checking, blistering, fading or chalking.

In a further example, an article 200, 300, 400, or an article 100 to which a protective layer has been added, may be performance-tested as to abrasion resistance of a protective layer 224 by testing the article pursuant to ASTM D1044-99 “Standard Test Method for Resistance of Transparent Plastics to Surface Abrasion” (2007), the entirety of which is incorporated by reference into this specification. Testing is carried out in accordance with ASTM D1044-99, by subjecting the protective layer 224 to abrasion by a pair of Calibrase CS-10F wheels at a defined wheel weight load for a defined number of wheel rotational cycles. The defined wheel load is within a range of between 300 grams and 1,000 grams. The defined number of wheel rotational cycles is within a range of between 300 cycles and 2,000 cycles. The test results are expressed as a change, comparing readings before and after abrasion, in a percentage of light transmitted through the protective layer 224 that is scattered. Light scattering readings are taken utilizing an integrating sphere photometer. A protective layer 224 generating a light scattering reading for example of 1% before abrasion, and a light scattering reading of 4% after abrasion, is reported as a 3% delta change in light scattering under the ASTM D1044-99 test protocol. A protective layer 224 of an article 200, 300, 400 or such a layer added to an article 100 disclosed above may, for example, generate a mean abrasion resistance expressed as a delta change in light scattering under the ASTM D1044-99 test protocol of less than about 7%, or within a range of between about 3% and about 7%.

As an additional example, an article 100, 200, 300, 400 may be performance-tested as to salt spray resistance of the article, or of its substrate 102, 202, 402, or of a protective layer 224, by subjecting the article or such substrate 102, 202, 402 or protective layer 224 to exposure in a salt spray chamber to 5+/−1 parts by mass of sodium chloride in water at 35° C.+/−2° C. under an air pressure of 12 pounds per square inch for 10 cycles of a 24 hour exposure period totaling 240 exposure hours, as defined in ASTM B 117-07 (2007). An article 100, 200, 300, 400, or a substrate 102, 202, 402, or protective layer 224 of such an article, may following completion of the 240 hour test exposure then maintain unchanged coloration, maintain adhesion between the substrate and layer(s) of the article, and exhibit less than about 1% degradation of the light-reflective layer's solar reflectance resulting from the salt spray exposure testing. As another example, an article 100, 200, 300, 400, or a substrate 102, 202, 402, or protective layer 224 of such an article, may also following completion of the 240 hour test exposure then show no visually apparent cracking, checking, blistering, fading or chalking.

Further for example, an article 100, 200, 300 400 may be performance-tested as to accelerated weathering by subjecting the article to the test protocol in SAE International J1960, “Accelerated Exposure of Automotive Exterior Materials Using a Controlled Irradiance Water-Cooled Xenon Arc Apparatus” (10-2004). The article 100, 200, 300 400 is exposed to xenon arc irradiance according to the SAE J1960 test protocol for a selected time period within a range of between 400 hours and 3,000 hours. In an example, the irradiance period is 3,000 hours. Following completion of the xenon arc irradiance exposure, the article 100, 200, 300, 400 is evaluated as to delamination, corrosion, curvature, and stability of reflectivity. The article 100, 200, 300, 400 may, for example, exhibit no detectable delamination, exhibit no detectable corrosion, maintain curvature of the optically smooth third anterior surface 118, 218 or second anterior surface 418 within 10% of specifications, and exhibit less than about 10% degradation of the light-reflective layer's solar reflectance resulting from the xenon arc irradiance exposure.

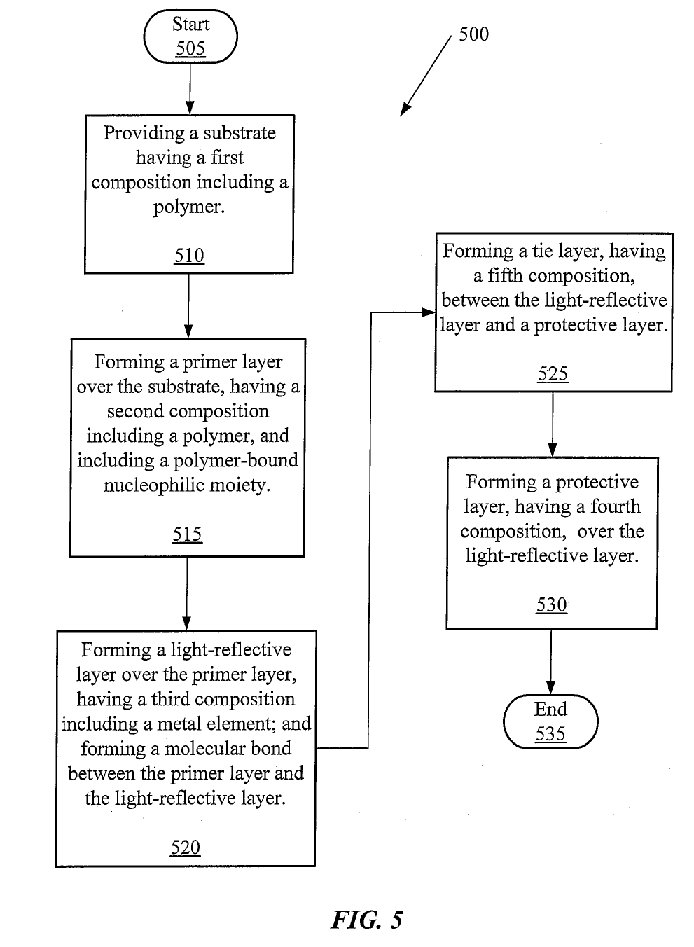

FIG. 5 is a flow chart showing an example of an implementation of a method 500. The method may be utilized, as examples, in fabricating an article 100, 200, 300 as discussed earlier and shown in FIGS. 1-3. The method starts at step 505, and then at step 510 a substrate 102, 202 is provided, having a first posterior surface 104, 204, a first anterior surface 106, 206, and a first composition including a polymer.

At step 515, a primer layer 108, 208 is formed over and having a second posterior surface 110, 210 facing the first anterior surface 106, 206 of the substrate 102, 202. The primer layer 108, 208 has a second anterior surface 112, 212. The primer layer 108, 208 has a second composition including a polymer, and including a polymer-bound nucleophilic moiety selected from carboxylic acids, organophosphorus acids, organosulfur acids, nitrocellulose, and a mixture of two or more of the foregoing.

A light-reflective layer 114, 214 is formed at step 520 over and having a third posterior surface 116, 216 facing the second anterior surface 112, 212 of the primer layer 108, 208, the light-reflective layer 114, 214 having an optically smooth third anterior surface 118, 218 and having a third composition including a metal element. Step 520 further includes forming a molecular bond between the primer layer 108, 208 and the light-reflective layer 114, 214, which may include forming a bonding interface 120, 220 of the second anterior surface 112, 212 and the third posterior surface 116, 216 during forming of the light-reflective layer 114, 214. The bonding interface 120, 220 includes a reaction product of the metal element and the polymer-bound nucleophilic moiety. The method 500 may, in an example, then end at step 535.

As a further example, step 515 may include polymerizing a monomer including a polymer-bound carboxylic acid nucleophilic moiety. Step 515 may include polymerizing a monomer by a process including ultraviolet light-induced polymerization. Forming the primer layer 108, 208 at step 515 may, in an example, include polymerizing a mono- or multi-functional acrylate monomer. Further, forming the primer layer 108, 208 at step 515 may include forming a molecular bond between the substrate 102, 202 and the primer layer 108, 208, which may include forming a second bonding interface 122, 222 of the first anterior surface 106, 206 and the second posterior surface 110, 210. The second bonding interface 122, 222 includes a reaction product of the first composition polymer and the polymer-bound nucleophilic moiety.

Forming the light-reflective layer 114, 214 at step 520 includes forming a molecular bond between the primer layer 108, 208 and the light-reflective layer 114, 214, which may include forming a salt that includes the metal element and the polymer-bound nucleophilic moiety. Step 520 may include forming the light-reflective layer 114, 214 over the primer layer 108, 208 utilizing a vacuum deposition process to deposit the third composition. The light-reflective layer 114, 214 may be formed at step 520 with an average thickness defined as the distance between the third posterior surfaces 116, 216 and third anterior surfaces 118, 218, as examples, within a range of between about 300 Angstroms and about 10,000 Angstroms, or within a range of between about 300 Angstroms and about 2,000 Angstroms, or within a range of between about 300 Angstroms and about 1,000 Angstroms, or within a range of between about 300 Angstroms and about 600 Angstroms. Step 520 may include utilizing a third composition including, for example, a metal element selected from chromium, aluminum, gold, and their alloys, and including forming a molecular bond between the third composition and the polymer-bound nucleophilic moiety, as examples.

The method 500 may include step 530, for example, including forming a protective layer 224 over and having a fourth posterior surface 226 facing the third anterior surface 218 of the light-reflective layer 214, the protective layer 224 having a fourth anterior surface 228, the protective layer 224 having a fourth composition that may include an organic composition, an inorganic composition, or both. As examples, the fourth composition may include an inorganic composition such as diamond-like carbon, aluminum nitride, silicon dioxide, C₂N₂, or a mixture of two or more of the foregoing. As further examples, the fourth composition may include an organic composition such as a poly(olefin), poly(vinyl chloride), poly(styrene), poly(fluoroethylene), poly(acrylate), poly(vinyl acid ester), poly(carbonate), poly(ester), poly(urethane), poly(amide), poly(unsaturated ester), poly(acrylonitrile butadiene styrene), poly (styrene acrylonitrile), or a mixture of two or more of the foregoing or including one or more inorganic compositions. As another example, step 530 may include forming a protective layer 224 having a fourth composition including diamond-like carbon. For example, step 530 may include forming the protective layer 224 including diamond-like carbon having an sp³ carbon atomic bond concentration within a range of between about 50% and about 90%. Further, step 530 may include, as an example, forming a molecular bond between the light-reflective layer 114, 214 and the protective layer 224. Forming this molecular bond may include forming a third bonding interface 230 of the third anterior surface 218 and the fourth posterior surface 226, the third bonding interface 230 including a reaction product of the metal and the diamond-like carbon.

As another example, the method 500 may include, at step 525 before step 530, forming a tie layer 302 interposed between the third anterior surface 218 of the light-reflective layer 214 and the fourth posterior surface 226 of the protective layer 224, the tie layer 302 having a fifth posterior surface 304 facing the third anterior surface 218, the tie layer 302 having a fifth anterior surface 306 facing the fourth posterior surface 226. For example, step 525 may include forming a tie layer 302 having a fifth composition including an inorganic compound, an organic metal-containing compound, or a mixture of the foregoing. As examples, the fifth composition may include a metal-containing compound selected from a silicon oxide, alumina, aluminum silicate, zirconium silicate, aluminum nitride, titanium oxide, zirconium oxide, alkyl titanate, alkyl zirconate, siloxane, alkyl silane, alkoxy silane, amino silane, and mixtures of two or more of the foregoing. Further, step 530 may follow step 525, where in step 530 forming the protective layer 224 may include forming a fourth composition including a polymer having a polymer-bound nucleophilic moiety selected from carboxylic acids, organophosphorus acids, organosulfur acids, nitrocellulose, and a mixture of two or more of the foregoing. In examples of the method 500 where step 530 or steps 525 and 530 are included, the method 500 may then end at step 535.

The method 500 may be modified for fabrication of the article 400 shown in FIG. 4. The modified method 500 may start at step 505, and then at step 510 a substrate 402 is provided, having a first posterior surface 404, a first anterior surface 406, and a first composition including a polymer having a polymer-bound nucleophilic moiety selected from carboxylic acids, organophosphorus acids, organosulfur acids, nitrocellulose, and a mixture of two or more of the foregoing. At step 520, a light-reflective layer 414 is formed over and having a second posterior surface 416 facing the first anterior surface 406, the light-reflective layer having an optically smooth second anterior surface 418, the light-reflective layer 414 having a third composition including a metal element. Step 520 further includes forming a molecular bond between the substrate 402 and the light-reflective layer 414. Step 520 may also include forming a bonding interface 420 of the first anterior surface 406 and the second posterior surface 416 during forming of the light-reflective layer 414, the bonding interface 420 including a reaction product of the metal element and the polymer-bound nucleophilic moiety. The method 500 may, in an example, then end at step 535. In another example, a protective layer (not shown) or a tie layer (not shown) and then a protective layer, may be added to the article 400 by including step 530 or steps 525 and 530 in the modified method 500.

The method 500 may include additional features. Step 510 may include preparations of the substrate 102, 202, 402 such as removing contaminants, for example by cleaning and deionizing the first anterior surface 106, 206, 406. Further, the first anterior surface 106, 206, 406 may be subjected to surface modification including treatment with a flame, plasma, corona discharge, and/or solvent.

Forming the primer layer 108, 208 in step 515 may include applying a liquid composition over the substrate 102, 202, polymerizeable to form the second composition, by dip coating, spray coating, flow coating, or another liquid application technique. Solvents for the liquid composition may be selected based on suitability for forming a smooth second anterior surface 112, 212, and for compatibility with the first composition of the substrate 102, 202. As an example, the coating technique may be selected and managed to form an optically smooth second anterior surface 112, 212. The composition coated on the first anterior surface 106, 206 for forming the second composition of the primer layer 108, 208 may be converted into the second composition by ultraviolet light—initiated polymerization including, as examples, free radical polymerization or latent photolytic—based polymerization. Step 515 may also include washing the second anterior surface 112, 212 after forming the primer layer 108, 208. Step 515 may further include a post-treatment of the primer layer 108, 208 in preparation for forming the light-reflective layer 114, 214. As examples, the second anterior surface 112, 212 of the primer layer 108, 208 may be subjected to a process for enhancing the chemical reactivity of the nucleophilic moieties at the second anterior surface 112, 212 selected from carboxylic acids, organophosphorus acids, organosulfur acids, nitrocellulose, and a mixture of two or more of the foregoing. Such an enhancement process may include, for example, treatment by a flame, plasma such as a plasma glow discharge, or ion gun, which may include utilizing an oxidizing atmosphere.

Forming the light-reflective layer 114, 214, 414 in step 520 may include depositing the third composition on the second anterior surface 112, 212, or first anterior surface 406 by a vacuum deposition process. As an example, reagents for forming the third composition may be evaporated in a vacuum and deposited onto the second anterior surface 112, 212, or first anterior surface 406. In another example, a magnetron sputtering process may be utilized for forming ions of the third composition in a vacuum and the ions may be deposited onto the second anterior surface 112, 212, or first anterior surface 406. It is understood by those skilled in the art that other processes for depositing a vapor including the third composition in one or more forms including atoms, ions and molecules in a vacuum environment onto the second anterior surface 112, 212, or first anterior surface 406 may be utilized. For example, other sputtering processes may be utilized. Dopants may be added to improve bonding to the primer layer 108, 208 or substrate 402 of a composition for forming the third composition. For example, silicon, boron, fluorine, and mixtures of two or more of the foregoing may be utilized. Following deposition of the third composition onto the second anterior surface 112, 212, or first anterior surface 406, step 520 may include one or more post-treatments such as ion bombardment to produce oxides of the third composition, or mechanical compaction, or annealing, or ion implantation, as examples.

Step 525 may include applying a liquid composition over the light-reflective layer 114, 214, 414 to form the fifth composition of the tie layer 302, by dip coating, spray coating, flow coating, or another liquid application technique. Solvents for the liquid composition may be selected based on suitability for forming a smooth fifth anterior surface 306, and for compatibility with the third composition of the light-reflective layer 114, 214, 414 and the fourth composition of the protective layer 224. As an example, the coating technique may be selected and managed to form an optically smooth fifth anterior surface 306. As an example, forming the tie layer 302 may include applying a sol-gel composition coating on the third anterior surface 118, 218, or second anterior surface 418, such as by dip coating, spray coating, flow coating, or another liquid application technique. The sol-gel composition coating may then be cured, for example by drying and heating, forming a metal oxide-containing fifth composition of the tie layer 302.

Step 530 may include forming the protective layer 224 by application of a composition for forming the fourth composition on the third or fifth anterior surface by a chemical vapor deposition process such as plasma enhanced chemical vapor deposition (PECVD) for example. For example, forming the protective layer 224 may include sputtering a metalloid composition by a PECVD process in the presence of a hydrocarbon gas such as methane. Such a composition may be cured to form the fourth composition of the protective layer 224 by ultraviolet light—initiated polymerization. In examples where the fourth composition includes diamond-like carbon, an ion beam plasma, cathodic arc or laser ablation process may be utilized. As another example, forming the protective layer 224 may include applying a sol-gel composition coating on the third anterior surface 118, 218, or second anterior surface 418, or fifth anterior surface 306, such as by dip coating, spray coating, flow coating, or another liquid application technique. The sol-gel composition coating may then be cured, for example by drying and heating, forming a metal oxide-containing fourth composition of the protective layer 224. Step 530 may also include application of an anti-reflective coating (not shown) on the protective layer 224 to minimize glare while maintaining transparency of the protective layer 224.

Further, the method 500 may include forming a protective backside coating on the first posterior surface 104, 204, 404 of the article 100, 200, 300, 400. As an example, the fourth composition of the protective layer 224 may be utilized. The side edges of the article 100, 200, 300, 400 perpendicular to the arrows 127, 227 may likewise be protectively coated.

The article 100, 200, 300, 400 may, for example, include end-utilization applications in or as myriad articles and apparatus having a reflective or shiny, chromed appearance, such as accent panels of portable devices including personal digital assistants, grilles, panels and insignia for vehicles and for other devices and apparatus, mirrors, architectural detailing, sales displays, personal accessories such as jewelry and sunglasses, decorative articles for furniture, and a wide array of other applications where a reflective or shiny metallic surface such as a mobile, portable or stationary surface of that nature is needed. Examples of mirrors include mirrors for automobiles, motorcycles, trucks, bicycles, other land vehicles, boats, ships, and aircraft, as well as mirrors for stationary or industrial end-uses. The articles 100, 200, 300, 400 may meet performance test standards required for commercial acceptability in various end-utilizations, such as the automotive field. Further, the articles 100, 200, 300, 400 may be light-weight. Likewise, the method 500 may be utilized for fabrication of any of these types of articles and apparatus, of which the articles 100, 200, 300, 400 are examples. The method 500 may be utilized to facilitate fabrication of articles 100, 200, 300, 400 having complex shapes, detailing, surfaces conforming to surfaces of other articles (not shown), and other structural features taking advantage of the capability of forming the articles 100, 200, 300, 400 to have a wide variety of dimensions, contours, and other selected structural specifications.

While the foregoing description refers in some instances to the articles 100, 200, 300, 400 as shown in FIGS. 1-4, it is appreciated that the subject matter is not limited to these structures, or to the structures discussed in the specification. Other shapes and configurations of articles may be fabricated. Further, it is understood by those skilled in the art that the method 500 may include additional steps and modifications of the indicated steps.

Moreover, it will be understood that the foregoing description of numerous examples has been presented for purposes of illustration and description. This description is not exhaustive and does not limit the claimed invention to the precise forms disclosed. Modifications and variations are possible in light of the above description or may be acquired from practicing the invention. The claims and their equivalents define the scope of the invention.

What is claimed is:

1. An article, comprising:
a substrate having a first posterior surface, a first anterior surface, and a first composition including a polymer;
a primer layer over and having a second posterior surface facing the first anterior surface, the primer layer having a second anterior surface;
the primer layer having a second composition including a polymer, and including a polymer-bound nucleophilic moiety selected from the group consisting of carboxylic acids, organophosphorus acids, organosulfur acids, nitrocellulose, and a mixture of two or more of the foregoing;
a light-reflective layer over and having a third posterior surface facing the second anterior surface, the light-reflective layer having an optically smooth third anterior surface and having a third composition including a metal element;
wherein the primer layer and the light-reflective layer are molecularly bonded together.

2. The article of claim 1, including a bonding interface of the second anterior surface and the third posterior surface, the bonding interface including a reaction product of the metal element and the polymer-bound nucleophilic moiety.

3. The article of claim 2, wherein the reaction product at the bonding interface includes a salt that includes the metal element and the polymer-bound nucleophilic moiety.

4. The article of claim 1, wherein the polymer-bound nucleophilic moiety is bound to the polymer of the second composition.

5. The article of claim 1, wherein the second composition includes an interpenetrating polymer network, and the polymer-bound nucleophilic moiety is bound to the interpenetrating polymer network.

6. The article of claim 5, including, bound to the polymer of the second composition, a polymer-bound nucleophilic moiety selected from the group consisting of carboxylic acids, organophosphorus acids, organosulfur acids, nitrocellulose, and a mixture of two or more of the foregoing.

7. The article of claim 1, wherein the polymer-bound nucleophilic moiety is a carboxylic acid.

8. The article of claim 1, wherein the primer layer is formed by a process including ultraviolet light-induced polymerization.

9. The article of claim 1, wherein the second composition includes a polymer having a moiety corresponding to an ethylenically unsaturated monomer.

10. The article of claim 1, wherein the second composition includes a polymer having a moiety corresponding to a mono- or multi-functional acrylate monomer.

11. The article of claim 1, wherein the substrate and the primer layer are molecularly bonded together.

12. The article of claim 1, including a second bonding interface of the first anterior surface and the second posterior surface, the second bonding interface including a reaction product of the first composition polymer and the polymer-bound nucleophilic moiety.

13. The article of claim 1, wherein the third composition includes a metal element selected from the group consisting of chromium, aluminum, silver, nickel, rhodium, gold, and their alloys.

14. The article of claim 1, wherein the third composition includes a metal element selected from the group consisting of chromium, aluminum, gold, and their alloys.

15. The article of claim 1, wherein the optically smooth third anterior surface has a first contour, the second anterior surface has a second contour, the first contour is substantially congruous with the second contour, and the first contour is selected from the group consisting of planar, convex, and concave.

16. The article of claim 1, wherein the light-reflective layer has an average thickness defined as the distance between the third posterior and third anterior surfaces within a range of between about 300 Angstroms and about 1000 Angstroms.

17. The article of claim 1, wherein the light-reflective layer is formed by vacuum deposition of the third composition over the second anterior surface.

18. The article of claim 1, including a protective layer having a fourth composition over and having a fourth posterior surface facing the third anterior surface, the protective layer having a fourth anterior surface, the light-reflective layer and the protective layer being molecularly bonded together.

19. The article of claim 18, including a third bonding interface of the third anterior surface and the fourth posterior surface, the third bonding interface including a reaction product of the metal and the fourth composition.

20. The article of claim 18, wherein the fourth composition includes a member selected from the group consisting of diamond-like carbon, aluminum nitride, silicon dioxide, C₂N₂, a poly(olefin), poly(vinyl chloride), poly(styrene), poly(fluoroethylene), poly(acrylate), poly(vinyl acid ester), poly(carbonate), poly(ester), poly(urethane), poly(amide), poly(unsaturated ester), poly(acrylonitrile butadiene styrene), poly(styrene acrylonitrile), and mixtures of two or more of the foregoing.

21. The article of claim 18, wherein the fourth composition includes diamond-like carbon.

22. The article of claim 21, wherein the diamond-like carbon has an sp³ carbon bond concentration within a range of between about 50% and about 90%.

23. The article of claim 18, including a tie layer interposed between the third anterior surface and the fourth posterior surface, the tie layer having a fifth posterior surface facing the third anterior surface, the tie layer having a fifth anterior surface facing the fourth posterior surface.

24. The article of claim 23, wherein the tie layer has a fifth composition including a metal-containing compound selected from the group consisting of a silicon oxide, alumina, aluminum silicate, zirconium silicate, aluminum nitride, titanium oxide, zirconium oxide, alkyl titanate, alkyl zirconate, siloxane, alkyl silane, alkoxy silane, amino silane, and mixtures of two or more of the foregoing.

25. The article of claim 24, wherein the fourth composition includes a polymer having a polymer-bound nucleophilic moiety selected from the group consisting of carboxylic acids, organophosphorus acids, organosulfur acids, nitrocellulose, and a mixture of two or more of the foregoing.

26. The article of claim 1, wherein the article generates a 5B adhesion test result according to Test Method B—Cross-Cut Tape Test defined in ASTM D 3359-02 (2006).

27. The article of claim 1, wherein the article maintains unchanged coloration, maintains adhesion between the substrate and layer(s), and exhibits less than about 1% degradation of the light-reflective layer's solar reflectance following four successive cycles of a twenty-four hour heat and moisture cycling program including 38+/−1° C. at 95-100% relative humidity for 16 hours, then -40+/−1° C. for a period of 4 hours, then 88+/−1° C. at 95-100% relative humidity for a period of 4 hours.

28. The article of claim 1, wherein the article generates a mean abrasion resistance expressed as a delta change in light scattering under the ASTM D1044-99 test protocol of less than about 7%.

29. The article of claim 1, wherein the article maintains unchanged coloration, maintains adhesion between the substrate and layer(s), and exhibits less than about 1% degradation of the light-reflective layer's solar reflectance following ten successive cycles of a twenty-four hour salt spray cycling program including exposure to 5+/−1 parts by mass of sodium chloride in water at 35° C.+/−2° C. under an air pressure of 12 pounds per square inch, totaling 240 exposure hours, as defined in ASTM B 117-07 (2007).

30. The article of claim 1, wherein following a 400 hour period of exposure to xenon arc irradiance according to the SAE J1960 test protocol, the article generates no detectable delamination or corrosion, maintains a curvature of the optically smooth third anterior surface within 10% of specifications, and exhibits less than about 10% degradation of the light-reflective layer's solar reflectance resulting from the xenon arc irradiance exposure.

31. A method, comprising:
providing a substrate having a first posterior surface, a first anterior surface, and a first composition including a polymer;
forming a primer layer over and having a second posterior surface facing the first anterior surface, the primer layer having a second anterior surface, including polymerizing monomers to form a second composition including a polymer, and including a polymer-bound nucleophilic moiety selected from the group consisting of carboxylic acids, organophosphorus acids, organosulfur acids, nitrocellulose, and a mixture of two or more of the foregoing; and
forming a light-reflective layer over and having a third posterior surface facing the second anterior surface, the light-reflective layer having an optically smooth third anterior surface and having a third composition including a metal element;
wherein forming the light-reflective layer includes molecularly bonding together the primer layer and the light-reflective layer.

32. The method of claim 31, wherein forming the light-reflective layer includes forming a bonding interface of the second anterior surface and the third posterior surface, the bonding interface including a reaction product of the metal element and the polymer-bound nucleophilic moiety.

33. The method of claim 32, wherein forming the reaction product includes forming a salt that includes the metal element and the polymer-bound nucleophilic moiety.

34. The method of claim 31, wherein forming the primer layer includes polymerizing a monomer including a carboxylic acid nucleophilic moiety.

35. The method of claim 31, wherein forming the primer layer includes polymerizing a monomer by a process including ultraviolet light-induced polymerization.

36. The method of claim 31, wherein forming the primer layer includes polymerizing a mono- or multi-functional acrylate monomer.

37. The method of claim 31, wherein forming the primer layer includes molecularly bonding together the substrate and the primer layer.

38. The method of claim 31, wherein forming the primer layer includes forming a second bonding interface of the first anterior surface and the second posterior surface, the second bonding interface including a reaction product of the first composition polymer and the polymer-bound nucleophilic moiety.

39. The method of claim 31, wherein forming the light-reflective layer over the primer layer includes utilizing a vacuum deposition process to deposit the third composition.

40. The method of claim 39, including forming the light-reflective layer with an average thickness defined as the distance between the third posterior and third anterior surfaces within a range of between about 300 Angstroms and about 600 Angstroms.

41. The method of claim 39, including utilizing a third composition including a metal element selected from the group consisting of chromium, aluminum, gold, and their alloys, and including forming a reaction product between the third composition and the polymer-bound nucleophilic moiety.

42. The method of claim 31, including forming a protective layer having a fourth composition over and having a fourth posterior surface facing the third anterior surface, the protective layer having a fourth anterior surface, and including molecularly bonding together the light-reflective layer and the protective layer.

43. The method of claim 42, wherein forming the protective layer includes forming a third bonding interface of the third anterior surface and the fourth posterior surface, the third bonding interface including a reaction product of the metal and the fourth composition.

44. The method of claim 42, wherein the fourth composition includes a member selected from the group consisting of diamond-like carbon, aluminum nitride, silicon dioxide, poly(urethane), C₂N₂, a poly(olefin), poly(vinyl chloride), poly(styrene), poly(fluoroethylene), poly(acrylate), poly(vinyl acid ester), poly(carbonate), poly(ester), poly(urethane), poly(amide), poly(unsaturated ester), poly(acrylonitrile butadiene styrene), poly(styrene acrylonitrile), and mixtures of two or more of the foregoing.

45. The method of claim 42, wherein the fourth composition includes diamond-like carbon having an sp³ bond concentration within a range of between about 50% and about 90%.

46. The method of claim 42, including forming a tie layer interposed between the third anterior surface and the fourth posterior surface, the tie layer having a fifth posterior surface facing the third anterior surface, the tie layer having a fifth anterior surface facing the fourth posterior surface.

47. The method of claim 46, including forming a tie layer having a fifth composition including a metal-containing compound selected from the group consisting of a silicon oxide, alumina, aluminum silicate, zirconium silicate, aluminum nitride, titanium oxide, zirconium oxide, alkyl titanate, alkyl zirconate, siloxane, alkyl silane, alkoxy silane, amino silane, and mixtures of two or more of the foregoing.

48. The method of claim 47, wherein forming the protective layer includes forming a fourth composition including a polymer having a polymer-bound nucleophilic moiety selected from the group consisting of carboxylic acids, organophosphorus acids, organosulfur acids, nitrocellulose, and a mixture of two or more of the foregoing.
